(19) United States
(12) Patent Application Publication
(10) Pub. No.: US 2018/0147884 A1
(43) Pub. Date: May 31, 2018

(54) DEVICE FOR MARKING LINES

(71) Applicant: Steven Ismert, Leawood, KS (US)

(72) Inventor: Steven Ismert, Leawood, KS (US)

(21) Appl. No.: 15/364,645

(22) Filed: Nov. 30, 2016

(51) Int. Cl. B44D 3/38

(52) U.S. Cl. CPC B44D 3/38

(57) ABSTRACT

A device for marking lines that includes: a strike line series of markings along the length of the strike line; a container, wherein container encloses the strike line during non-use within the container, wherein the reel holds the strike line; and an opening within the container adapted to allow the extension of the strike line over a flat surface. The markings along the strike line are preferably spaced at 16 inches apart.

### BACKGROUND OF THE INVENTION

### Field of Invention

The present invention relates to a device for marking lines in a construction area.

### Description of Related Art

Chalk lines are used on construction sites to lay out and measure various surfaces. Chalk lines are usually held taut and placed in appropriate position, where the chalk line marks all the points that the string touches once the line is snapped in place. The use of construction chalk lines is an important tool that is used to ensure construction layout is properly placed prior to the installation of various structures. The chalk line is marked through the use of a chalk box that contains the line that extends from the box. The line is coated with a loose dye so that when a string is laid across the surface it may be marked by pulling tight and then snapping the line sharply that allows the transfer of chalk onto the surface of where the striking takes place. It is typically used on relatively flat surfaces along the same plane. This construction technique has been used for many, many years along with the use of plumb-bobs. Although these chalk lines are important in providing a guideline for construction workers it would be advantageous if the chalk lines could further provide a measurement aspect. Such as used with traditional construction spacing of the 16 inch in order to eliminate further need for measurement after the striking of a chalk line.

### SUMMARY OF THE INVENTION

The present invention relates to a device for marking lines that includes: a strike line series of markings along the length of the strike line; a container, wherein container encloses the strike line during non-use within the container, wherein the reel holds the strike line; and an opening within the container adapted to allow the extension of the strike line over a flat surface. The markings along the strike line are preferably spaced at 16 inches apart.

### BRIEF DESCRIPTION OF DRAWINGS

FIG. 1 depicts a chalk line system in accordance with the present invention.

### DETAILED DESCRIPTION

The present invention relates to a device for marking lines similar to the traditional chalk line used in construction. The present invention provides an improvement in that measured spacing is provided across the length of the chalk line. This measured spacing is created through strips integrated within the chalk line in accordance with the present invention. The stripping is spaced at a 16-inch spacing to create distinct measurements along the chalk line. This eliminates the need for additional measurements after the striking of this chalk line.

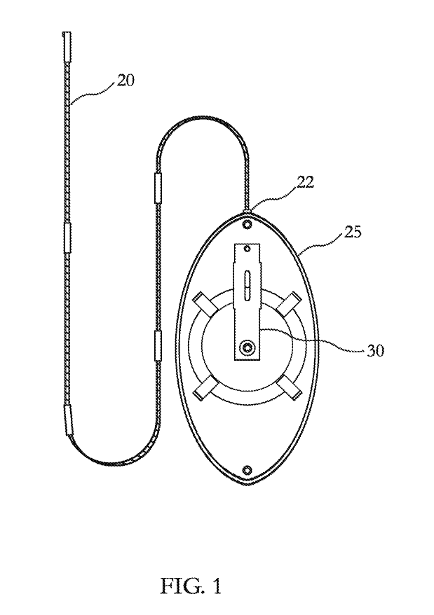

In reference to FIG. 1, a Chalk Box 25 is depicted. The Chalk Box 25 includes Chalk Line 20 with stripe markings along the length of the chalk line. These markings are spaced at 16 inches apart therefore providing measured marking for a construction worker once the line is struck. This technique cuts the preparation time for installation of studs and drywall. Since the space markings are present once the chalk line is struck, by using the Chalk Line 20 a worker may reduce installation time of wall paneling and studs if needed. Chalk Box 25 includes Opening 22 that releases Chalk Line 20 for use. Further, Reel 30 is provided within the Chalk Box 25 to reel Chalk Line 20 into the Chalk Box 25 into a closed position. This unique chalk line therefore provides a more efficiency for a construction worker.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A device for marking lines comprising:
a. a strike line
b. series of markings along the length of the strike line;
c. a container, wherein container encloses the strike line during non-use within the container, wherein the reel holds the strike line; and
d. an opening within the container adapted to allow the extension of the strike line over a flat surface.

2. The device for marking lines according to claim 1, wherein the markings along the strike line are spaced at 16 inches apart.
